(19) United States
(12) Patent Application Publication
(10) Pub. No.: US 2019/0349519 A1
(43) Pub. Date: Nov. 14, 2019

(54) ELECTRONIC DEVICE AND IMAGE PROCESSING METHOD THEREFOR

(71) Applicant: Samsung Electronics Co., Ltd., Gyeonggi-do (KR)

(72) Inventors: Sangjin LEE, Gyeonggi-do (KR); Seunghye CHYUNG, Gyeonggi-do (KR); Ildo KIM, Gyeonggi-do (KR); Jaegon KIM, Gyeonggi-do (KR); Yongju LEE, Gyeonggi-do (KR); Changgwun LEE, Gyeonggi-do (KR); Nari IM, Gyeonggi-do (KR); Hyeyun JUNG, Gyeonggi-do (KR); Jiyoon PARK, Gyeonggi-do (KR); Jonghoon WON, Gyeonggi-do (KR)

(21) Appl. No.: 16/373,730

(22) Filed: Apr. 3, 2019

(30) Foreign Application Priority Data
May 9, 2018 (KR) 10-2018-0053361

(51) Int. Cl. H04N 5/232; G06F 3/0484; G06T 7/12; H04N 5/445

(52) U.S. Cl. CPC H04N 5/23229; G06F 3/04842; H04N 2005/44578; H04N 5/44543; G06T 7/12

(57) ABSTRACT

Provided, among other embodiments, is an electronic device including a memory and at least one processor. The at least one processor is configured to recognize at least one object having a curved portion in an image; determine a curvature corresponding to at least a part of the curved portion of the at least one object; determine a filter attribute based on at least a number of pixels located on a pre-existing graphical object of a specified curve corresponding to the curvature among one or more pixels representing the at least a part of the curved portion in the image; and correct at least a part of the curved portion using a filter set based on at least the filter attribute.

### CROSS-REFERENCE TO RELATED APPLICATION(S)

This application is based on and claims priority under 35 U.S.C. § 119 to Korean Patent Application No. 10-2018-0053361, filed on May 9, 2018, in the Korean Intellectual Property Office, the disclosure of which is incorporated by reference herein in its entirety.

### TECHNICAL FIELD

Certain embodiments of the present disclosure relate to an electronic device capable of processing images and an image processing method therefor.

### BACKGROUND

Electronic device can be capable of taking photographs using an integrated camera. The camera obtains what is known as a raw image. However, the raw image may not have acceptable quality due to various affects such as brightness, distortion, or blurriness.

### SUMMARY

An electronic device capable of processing images can obtain a raw image through an image sensor and process the obtained raw image using an internal image signal processor (ISP). The image signal processor can process the received raw image by using image enhancement algorithms, thereby providing an image with improved quality. The image signal processor can perform various processing operations, such as white balance adjustment, color adjustment (e.g., color matrix, color correction, or color enhancement), color filter array interpolation, noise reduction or sharpening, and image enhancement (e.g., high dynamic range (HDR), and face detection). The output image of the image signal processor may have, for example, a pixel format, such as the YUV format. The image output from the image signal processor may also be compressed according to a standard such as the Joint Pictures Expert Group (JPEG). The compressed image may be stored in the electronic device.

The electronic device may apply a filter to an image to process the image. The filter applied to an image can have various filter attributes. When determining a filter attribute for processing an image, the electronic device may examine the results of applying various filters or filter attributes first and then determine the appropriate filter or filter attribute.

Accordingly, an aspect of the present disclosure may provide an electronic device and image processing method therefor that can adaptively process an image according to an object included in the image.

In accordance with an aspect of the present disclosure, an electronic device is provided. The electronic device may include a memory and at least one processor. The at least one processor is configured to recognize at least one object having a curved portion in an image; determine a curvature corresponding to at least a part of the curved portion of the at least one object; determine a filter attribute based on at least a number of pixels located on a pre-existing graphical object of a specified curve corresponding to the curvature among one or more pixels representing the at least a part of the curved portion in the image; and correct at least a part of the curved portion using a filter set based on at least the filter attribute.

In accordance with another aspect of the present disclosure, there is provided a method of image processing for an electronic device. The method may include: recognizing at least one object having a curved portion in an image; determining a curvature corresponding to at least a part of the curved portion of the at least one object; determining a filter attribute based on at least a number of pixels located on a pre-existing graphical object of a specified curve corresponding to the curvature among one or more pixels representing the at least a part of the curved portion in the image; and correcting at least a part of the curved portion by using a filter set based on at least the filter attribute.

In a feature of the present disclosure, the electronic device and image processing method thereof can adaptively process an image according to an object included in the image.

In another feature of the present disclosure, the electronic device and image processing method thereof can determine an appropriate filter attribute based on an object included in the image to be processed.

In another feature of the present disclosure, for an object having a curved portion included in an image, the electronic device and image processing method thereof can adaptively determine an appropriate filter attribute corresponding to the curvature of the curved portion and correct the image by applying a filter having the determined filter attribute to the image.

### BRIEF DESCRIPTION OF THE DRAWINGS

FIG. 1 is a block diagram of an electronic device 101 in a network environment 100 according to certain embodiments.

FIG. 2 is a block diagram 200 of a camera 180 according to certain embodiments.

FIG. 3 is a conceptual diagram illustrating the operations of the electronic device and an external electronic device according to certain embodiments of the present disclosure.

FIG. 4A and FIG. 4B illustrate operations of the electronic device according to certain embodiments of the present disclosure.

FIG. 5 illustrates operations of the electronic device according to certain embodiments of the present disclosure.

FIG. 6 illustrates operations of the electronic device according to certain embodiments of the present disclosure.

FIG. 7A and FIG. 7B illustrate operations of the electronic device according to certain embodiments of the present disclosure.

FIG. 8 illustrates operations of the electronic device according to certain embodiments of the present disclosure.

FIG. 9 is a flowchart of an image processing method of the electronic device according to certain embodiments of the present disclosure.

### DETAILED DESCRIPTION

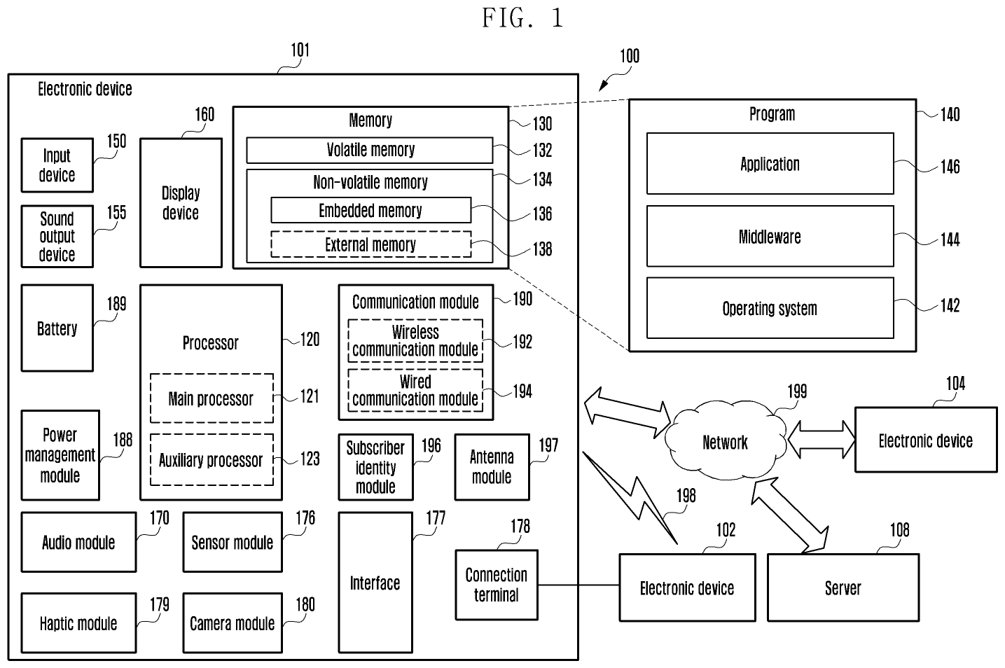

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera 180, a power management module 188, a battery 189, a communication module 190, a subscriber identification module (SIM) 196, or an antenna module 197. In some embodiments, at least one (e.g., the display device 160 or the camera 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

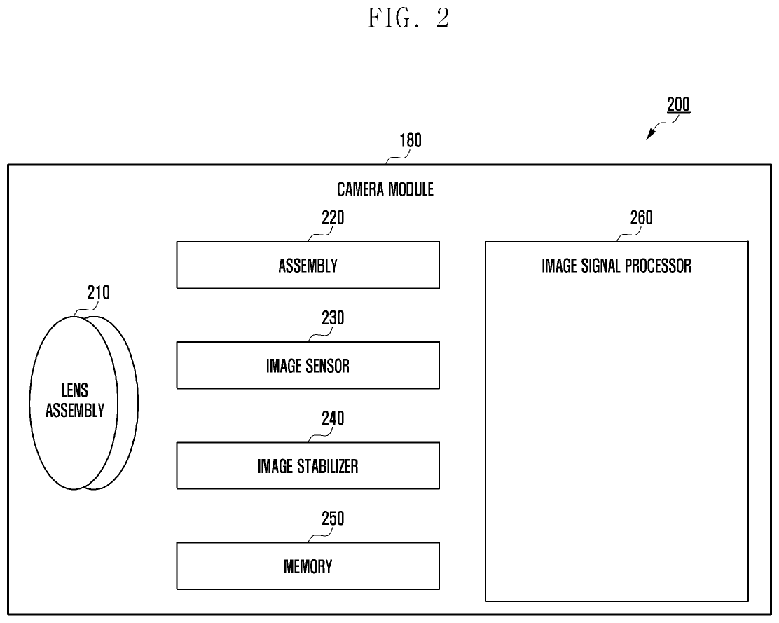

The camera 180 may capture a still image or moving images. According to an embodiment, the camera 180 may include one or more lenses, image sensors, image signal processors, or flashes. The camera 180 will be described in greater detail in FIG. 2.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

FIG. 2 is a block diagram 200 illustrating the camera 180 according to certain embodiments. Referring to FIG. 2, the camera 180 may include a lens assembly 210, a flash 220, an image sensor 230, an image stabilizer 240, memory 250 (e.g., buffer memory), or an image signal processor 260. In certain embodiments, the image signal processor 260 may be located away from the camera 180, such as integrated with the processor 120. The lens assembly 210 may collect light emitted or reflected from an object whose image is to be taken. The lens assembly 210 may include one or more lenses. According to an embodiment, the camera 180 may include a plurality of lens assemblies 210. In such a case, the camera 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera 180 or the electronic device 101 including the camera 180. This allows compensating for at least part of a negative effect (e.g., image blurring) by the movement on an image being captured. According to an embodiment, the image stabilizer 240 may sense such a movement by the camera 180 or the electronic device 101 using a gyro sensor (not shown) or an acceleration sensor (not shown) disposed inside or outside the camera 180. According to an embodiment, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera 180. An image processed by the image signal processor 260 may be stored back in the memory 250 for further processing, or may be provided to an external component (e.g., the memory 130, the display device 160, the electronic device 102, the electronic device 104, or the server 108) outside the camera 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display device 160 as it is or after being further processed.

According to an embodiment, the electronic device 101 may include a plurality of cameras 180 having different attributes or functions. In such a case, at least one of the plurality of cameras 180 may form, for example, a wide-angle camera and at least another of the plurality of cameras 180 may form a telephoto camera. Similarly, at least one of the plurality of cameras 180 may form, for example, a front camera and at least another of the plurality of cameras 180 may form a rear camera.

It is noted that operations for improving the quality of a raw image can either be performed locally or using distributed processing. For example, certain processes can be performed using cloud computing.

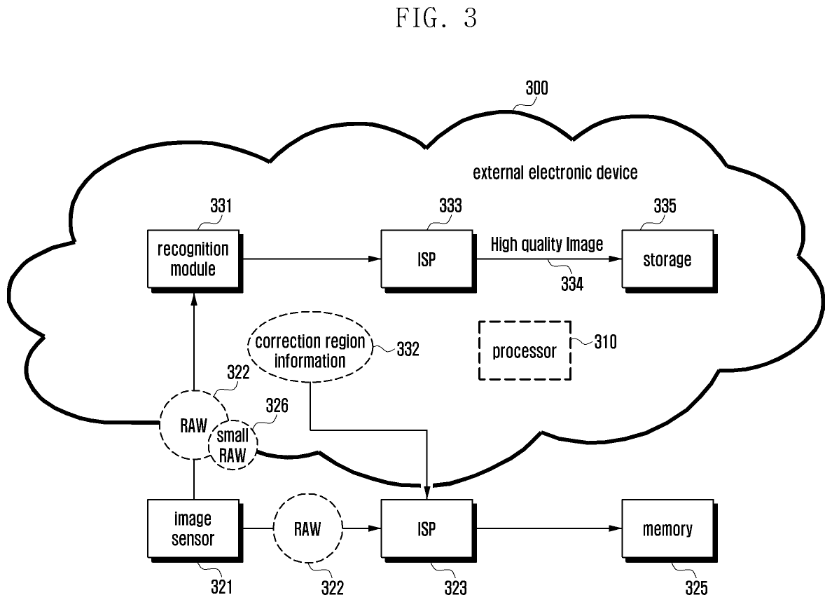

FIG. 3 is a conceptual diagram illustrating the operations of the electronic device and an external electronic device according to certain embodiments of the present disclosure.

The electronic device (e.g., electronic device 101 in FIG. 1) may include an image sensor 321, an ISP 323, and a memory 325. The external electronic device 300 (e.g., server 108 in FIG. 1) may include a recognition module 331, an ISP 333, and a storage 335. The recognition module 331 may be a logic module and may be implemented by the processor 310 (e.g., processor 120 in FIG. 1, or image signal processor 260 in FIG. 2) of the external electronic device 300. For example, at least some of the processing operations of the processor 310 of the external electronic device 300 may be performed by the electronic device (e.g., electronic device 100 in FIG. 1 with the processor 120 in FIG. 1 or the image signal processor 260 in FIG. 2). The ISP 333 may also be implemented by the processor 310 of the external electronic device 300, and the processor 310 of the external electronic device 300 may perform both recognition and image processing, for example.

Although not shown, the electronic device (e.g., electronic device 101 in FIG. 1) may include a communication module (e.g., communication interface 177, or communication module 190) capable of sending and receiving data to and from the external electronic device 300 (e.g., server 108 in FIG. 1). The external electronic device 300 (e.g., server 108 in FIG. 1) may also include a communication module capable of sending and receiving data to and from the electronic device (e.g., electronic device 101 of FIG. 1).

The image sensor 321 (e.g., camera 291) can obtain an image of an external object, or one or more external objects, and generate a corresponding raw image 322. The image sensor 321 may forward the raw image 322 to the ISP 323. In certain embodiments, the image sensor 321 may generate a low data raw image 326 and transmit it to the external electronic device 300 through the communication module. In one embodiment, the processor 310 (e.g., processor 120) of the electronic device 101 other than the image sensor 321 may generate a low data raw image 326, and send the generated low data raw image 326 to the external electronic device 300 (e.g., server 108) via the communication module. For example, the image sensor 321 can compress the raw image 322, thereby resulting in the low data raw image, and transmit it to the ISP or the external electronic device 300. The image sensor 321 may store the compressed raw image 322 in an internal memory inside the image sensor 321 for partial processing of the raw image 322.

The recognition module 331 of the external electronic device 300 can obtain a low data raw image 326 through the communication module and can segment the low data raw image 326 into one or more image regions. In certain embodiments, the low data raw image can be compressed according to the JPEG standard, and the segments can be the Minimum Coded Unit (MCU block). The recognition module 321 can recognize each of the segmented image regions. It is possible to generate correction region information 332 including information associated with the image regions generated by the recognition module 321 (e.g., at least one of coordinate information of the image regions or recognition results). The correction region information 332 may be sent to the electronic device (e.g., electronic device 101 in FIG. 1). The ISP 323 can use the correction region information 332 to correct the raw image 322, and thus the corrected image 324 can be generated. The corrected image 324 may have, for example, a YUV pixel format. The corrected image 324 may be stored in the memory 325. Alternatively, the corrected image 324 may be compressed based on, for example, the JPEG scheme, and the compressed image may be stored in the memory 325.

In certain embodiments, the raw image 322 obtained from the image sensor 321 may be transmitted to the external electronic device 300 separately from the low data raw image 326. As the raw image 322 has a larger volume than the low data raw image 326, the low data raw image 326 is first transmitted to the external electronic device 300 and then the raw image 322 can be transmitted to the external electronic device 300. For example, the raw image 322 may be transmitted to the external electronic device 300 while the ISP 323 performs a correction operation on the raw image 322.

The raw image 322 may be uploaded to the external electronic device 300 without change after being generated by the image sensor 321, or a preprocessed image to which lens distortion compensation or noise removal has been applied may be uploaded. The above-described preprocessing may be performed in the external electronic device 300. The external electronic device 300 may perform de-mosaicing, image format conversion, or preprocessing for increasing the image recognition rate. The ISP 333 of the external electronic device 300 can correct the received raw image 322. The external electronic device 300 may correct the raw image 322 using the previously generated correction region information 332 or may correct the raw image 322 using the extended correction region information. As the raw image 322 may have a higher resolution than the small raw image 326, the ISP 333 of the external electronic device 300 can obtain more detailed extended correction region information from the higher quality image.

The ISP 333 may generate the extended correction region information by using the existing correction region information and the raw image 322 together. The ISP 333 can obtain a high quality image 334 by correcting the raw image 322 using the extended correction region information. The high quality image 334 may be stored in the storage 335 of the external electronic device 300, and may be downloaded to the electronic device 101.

The external electronic device 300 (e.g., server 108 in FIG. 1) may be implemented, for example, as a cloud server, so that the ISP 333 of the external electronic device may be referred to as a cloud ISP. The ISP 333 of the external electronic device may perform at least one of the correction operations including original color mapping, detail regeneration, text reconstruction, image inpainting, scene based white balancing, color adjustment, segmentation based noise reduction (NR), sharpening, and segmentation based detail enhancement. In certain embodiments, the external electronic device 300 (e.g., server 108 in FIG. 1) may include some components corresponding to those of the electronic device (e.g., electronic device 101 in FIG. 1). For example, the external electronic device 300 may include a component (e.g., image signal processor) corresponding to one of the components of the camera 180 of FIG. 2.

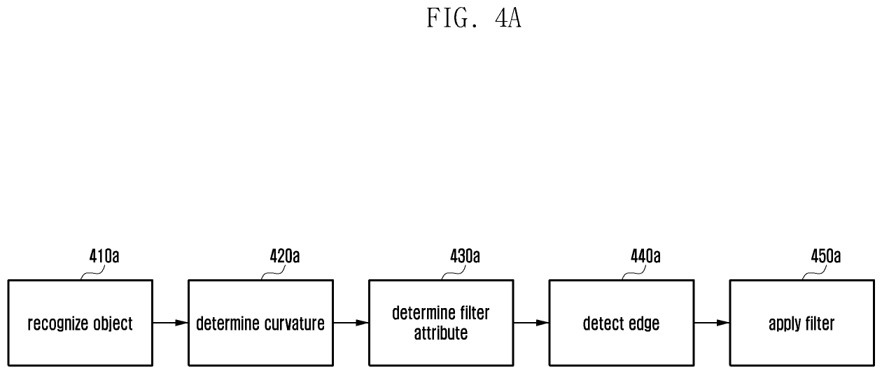

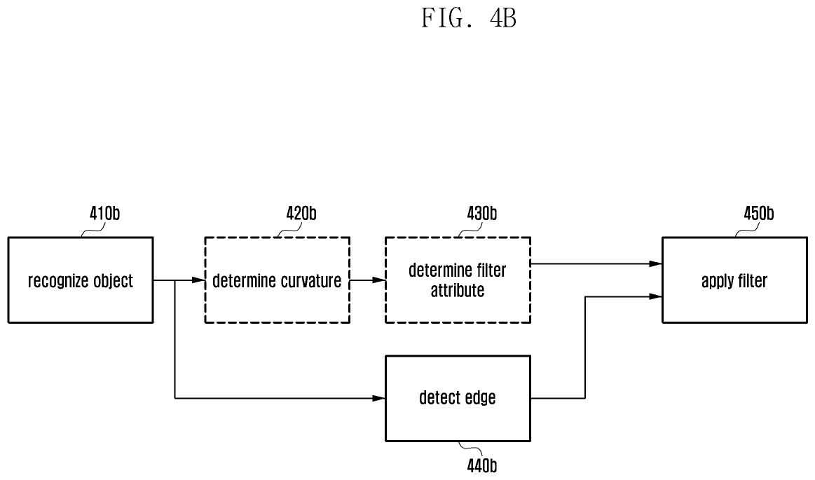

FIGS. 4A and 4B illustrate operations of the electronic device according to certain embodiments of the present disclosure.

FIG. 4A shows a flow whereby the electronic device (e.g., electronic device 101 in FIG. 1 (processor 120), server 108 (processor of the server), or external electronic device 300 in FIG. 3) performs edge detection by using an adaptively determined number of filter taps. Edge detection can be performed by detecting discontinuities in brightness or pixel values.

In one embodiment, at operation 410a, the electronic device (e.g., electronic device 101 in FIG. 1 (processor 120), server 108 (processor of the server), or external electronic device 300 (processor 310 or recognition module 331)) may recognize an object in the image. In certain embodiments, an object can be recognized by detection of a closed loop edge and comparison of the closed loop edge with commonly known shapes that appears in images. In one embodiment, based on image recognition, the electronic device (e.g., electronic device 101 in FIG. 1) may recognize at least one object having a curved portion among the objects included in the image. For example, the electronic device (e.g., electronic device 101 in FIG. 1) can recognize objects in the image and select at least one object having a curved portion (e.g., human hair) from among the objects. In certain embodiments, “a curved portion” can comprise an edge deviating by more than a predetermined amount within a certain length from a straight line.

In one embodiment, at operation 420a, the electronic device (e.g., electronic device 101 in FIG. 1 (processor 120), server 108 (processor of the server), or external electronic device 300 in FIG. 3 (processor 310 or ISP 333)) may determine a curvature corresponding to the curved portion of the recognized object.

In one embodiment, the electronic device (e.g., electronic device 101 in FIG. 1 (processor 120), or server 108 (processor of the server)) may determine a virtual graphical object corresponding to the curvature of the curved portion of the edge of the object. In one embodiment, the electronic device (e.g., electronic device 101 in FIG. 1) can determine the curvature by comparing the curved portion with a curve having a specified characteristic (e.g., circle, ellipse, or arc). For example, the electronic device (e.g., electronic device 101 in FIG. 1) may compare the curved portion with curves having different curvatures (e.g., circle, ellipse, and arc) and determine the curvature of the curve matching the curved portion as the curvature of the curved portion of the recognized object. For example, the electronic device can determine the curvature of the curved portion of the recognized object by comparing the curved portion of the recognized object with at least a part of a figure having a specific curvature. For instance, when comparing a circle with the object, the electronic device (e.g., electronic device 101 in FIG. 1) can determine the curvature of the circle by using the diameter, radius, or circumference of the circle. In one embodiment, the electronic device (e.g., electronic device 101 in FIG. 1) may determine a part of the curve (e.g., circle, ellipse, or arc) matching the curved portion as a virtual graphical object. In certain embodiments, a virtual graphical object can be a pre-stored image or model of an object that commonly appears in images, such as a human face, human features, etc.

In one embodiment, at operation 430a, the electronic device (e.g., electronic device 101 in FIG. 1 (processor 120), server 108 (processor of the server), or external electronic device 300 in FIG. 3 (processor 310 or ISP 333)) may determine the attribute of the filter based on the determined curvature. For example, the attributes of the filter may include at least one of the number of filter taps, the cutoff frequency, the center frequency, the filter type, the cutoff band, the passband, or the passband gain. In one embodiment, the electronic device (e.g., electronic device 101 in FIG. 1) may determine the attribute of the filter based on at least the number of pixels located on the graphical object of the specified curve corresponding to the curvature among the pixels representing the curved portion included in the image. For example, the virtual graphical object may correspond to the curvature of the curved portion of the object in the image. For example, the virtual graphical object may be in the form of a circle or part of a circle having the same curvature as the curved portion. In certain embodiments, the virtual graphical object may be one of various types of figures (e.g., circles, ellipses, and arcs) or may be a part of each of such figures. For example, the electronic device (e.g., electronic device 101 in FIG. 1) may recognize the number of pixels 630 located on a virtual graphical object 610. For example, the electronic device (e.g., electronic device 101 in FIG. 1) may recognize the number of pixels located on a tangent line of the virtual graphical object 610 and also located on the virtual graphical object 610.

In one embodiment, the electronic device (e.g., electronic device 101 in FIG. 1 (processor 120), server 108 (processor of the server), or external electronic device 300 in FIG. 3 (processor 310 or ISP 333)) may determine the attributes of the filter based on at least the number of recognized pixels. For example, the electronic device (e.g., electronic device 101 in FIG. 1) may determine the number of recognized pixels as the number of filter taps.

In one embodiment, at operation 440a, the electronic device (e.g., electronic device 101 in FIG. 1 (processor 120), or server 108 (processor of the server)) may detect an edge of the object in the image. For example, the electronic device (e.g., electronic device 101 in FIG. 1) may apply various edge detection techniques to detect an edge of the object in the image, such as filters to detect sharp discontinuities in the brightness or pixel values.

In one embodiment, at operation 450a, the electronic device (e.g., electronic device 101 in FIG. 1 (processor 120), server 108 (processor of the server), or external electronic device 300 in FIG. 3 (processor 310 or ISP 333)) may apply a filter to the image based on the determined filter attribute. In one embodiment, the electronic device (e.g., electronic device 101 in FIG. 1) may apply the filter in a direction corresponding to the edge of the object in the image based on the determined filter attribute (e.g., number of filter taps). For example, the electronic device (e.g., electronic device 101 in FIG. 1) may apply the filter in a direction relative to the edge detected at operation 440a. For example, the electronic device (e.g., electronic device 101 in FIG. 1) may apply the filter to each pixel of the image in a tangential direction of the detected edge. In one embodiment, the electronic device (e.g., electronic device 101 in FIG. 1) may use a filter having a determined number of filter taps to determine the direction to which the filter is to be applied.

In one embodiment, the electronic device (e.g., electronic device 101 in FIG. 1 (processor 120), or server 108 (processor of the server)) can correct at least a part of the curved portion in the image by applying the filter. For example, the electronic device (e.g., electronic device 101 in FIG. 1) may perform edge enhancement on the curved portion. For example, through image correction, the electronic device (e.g., electronic device 101 in FIG. 1) can enhance the resolution of the image (object), make the curved portion more neat or smooth, or more sharply correct the color, brightness, or saturation of the image (object).

Generally, sharpening the edges is useful where the picture appears blurry. Smoothing the picture is useful when there is certain types of noise, such as a “salt and pepper” noise, visible stripes in pixel color change, or “jagged” edges where the edges are diagonal.

FIG. 4B shows a flow whereby the electronic device (e.g., electronic device 101 in FIG. 1 (processor 120), server 108 (processor of the server), or external electronic device 300 in FIG. 3 (processor 310, recognition module 331, or ISP 333)) performs edge detection by using a fixed number of filter taps.

In one embodiment, at operation 410b, the electronic device (e.g., electronic device 101 in FIG. 1 (processor 120), or server 108 (processor of the server)) may recognize an object in the image. In one embodiment, the electronic device (e.g., electronic device 101 in FIG. 1) can distinguish between an object having a curved portion and an object not having a curved portion among the objects included in the image on the basis of image recognition.

In one embodiment, at operation 420b, if there is an object having a curved portion in the image, the electronic device (e.g., electronic device 101 in FIG. 1 (processor 120), or server 108 (processor of the server)) may determine the curvature corresponding to at least a part of the curved portion of the recognized object. In one embodiment, the electronic device (e.g., electronic device 101 in FIG. 1 (processor 120), or server 108 (processor of the server)) may determine a virtual graphical object corresponding to the curvature of the curved portion. In one embodiment, the electronic device (e.g., electronic device 101 in FIG. 1) can determine the curvature by comparing the curved portion with a curve having a specified characteristic (e.g., circle, ellipse, or arc). For example, the electronic device (e.g., electronic device 101 in FIG. 1) may compare the curved portion with curves having different curvatures (e.g., circle, ellipse, and arc) and determine the curvature of the curve matching the curved portion as the curvature of the curved portion of the recognized object. In one embodiment, if there is no object having a curved portion in the image, the electronic device (e.g., electronic device 101 in FIG. 1 (processor 120), or server 108 (processor of the server)) may skip operation 420b for curvature determination.

In one embodiment, at operation 430b, the electronic device (e.g., electronic device 101 in FIG. 1 (processor 120), or server 108 (processor of the server)) may determine the attribute of the filter based on the determined curvature. In one embodiment, the electronic device (e.g., electronic device 101 in FIG. 1 (processor 120), or server 108 (processor of the server)) may determine the attribute of the filter based on at least the number of pixels located on the graphical object of the specified curve corresponding to the curvature among the pixels representing the curved portion included in the image. For example, the electronic device (e.g., electronic device 101 in FIG. 1) may determine the number of recognized pixels as the number of filter taps. In one embodiment, if there is no object having a curved portion in the image, the electronic device (e.g., electronic device 101 in FIG. 1 (processor 120), or server 108 (processor of the server)) may apply a fixed number of filter taps. For example, if there is no object having a curved portion in the image, the electronic device (e.g., electronic device 101 in FIG. 1) can apply a specified number of filter taps as the filter attribute according to the initial setting or an input of the user. In one embodiment, at operation 440b, the electronic device (e.g., electronic device 101 in FIG. 1 (processor 120), or server 108 (processor of the server)) may detect an edge of the object in the image. For example, the electronic device (e.g., electronic device 101 in FIG. 1) may apply various edge detection techniques to detect an edge of the object in the image.

In one embodiment, at operation 450b, the electronic device (e.g., electronic device 101 in FIG. 1 (processor 120), or server 108 (processor of the server)) may apply the filter in a direction corresponding to the edge of the object in the image based on the determined filter attribute. For example, the electronic device (e.g., electronic device 101 in FIG. 1) may apply the filter to each pixel of the image in a direction tangential to the direction of the edge detected at operation 440b. In one embodiment, the electronic device (e.g., electronic device 101 in FIG. 1) can correct at least a part of the object in the image by applying the filter. For example, the electronic device (e.g., electronic device 101 in FIG. 1) may perform edge enhancement on the object in the image. For example, through image correction, the electronic device (e.g., electronic device 101 in FIG. 1) can enhance the resolution of the image (object) or more sharply correct the color, brightness, or saturation of the image (object).

In certain embodiments, the electronic device (e.g., electronic device 101 in FIG. 1 (processor 120), or server 108 (processor of the server)) can independently perform the operation of determining the filter attribute according to the curvature of the object in the image and the operation of detecting an edge in the image. For example, the electronic device may correct the image by determining the filter attribute (e.g., number of filter taps) according to the curvature of the object in the image in operations 420b and 430b similarly to operations 420a and 430a of FIG. 4A. For example, at edge detection operation 440b, unlike operation 440a of FIG. 4A, the electronic device may perform edge detection based on a preset filter attribute (e.g., preset number of filter taps) regardless of the curvature of the object. For example, the electronic device (e.g., electronic device 101 in FIG. 1 (processor 120), or server 108 (processor of the server)) may perform edge detection operation 430b based on a fixed filter attribute (e.g., number of filter taps).

### Recognizing the Object and Determining Curvature

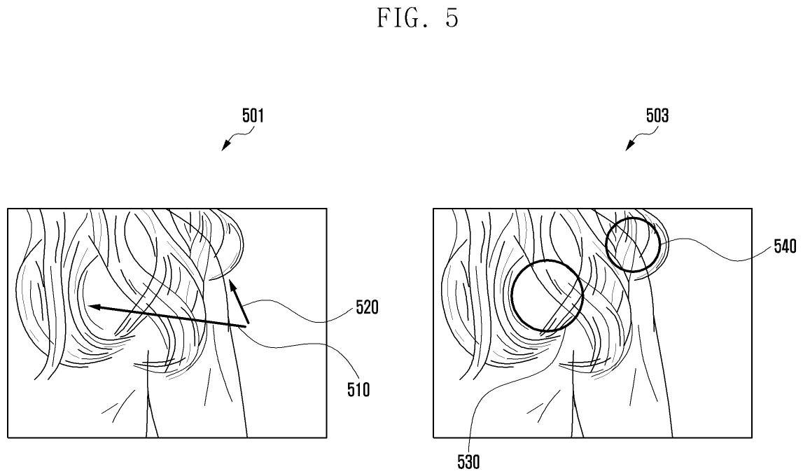

FIG. 5 illustrates operations of the electronic device according to certain embodiments of the present disclosure. Specifically, FIG. 5 illustrates operations of the electronic device to recognize an object in the image and determine the curvature.

In one embodiment, the electronic device (e.g., electronic device 101 in FIG. 1 (processor 120), server 108 (processor of the server), or external electronic device 300 in FIG. 3 (processor 310, recognition module 331, or ISP 333)) may recognize at least one object having a curved portion among the objects included in the image based on image recognition. For example, as indicated by indicia 501, the electronic device (e.g., electronic device 101 in FIG. 1 (processor 120)) may recognize a human hair part including a curved portion among the objects in the image (e.g., hairs, clothes, human body, or background). As indicated by indicia 501, the human hair part may have various patterns of bending. For example, the electronic device (e.g., electronic device 101 in FIG. 1) can recognize a portion of hair part 510, 520 curved towards the rightcurved. In certain embodiments, the electronic device (e.g., electronic device 101 in FIG. 1) may recognize various types of objects having a curved portion in the image other than human hairs.

In one embodiment, the electronic device (e.g., electronic device 101 in FIG. 1 (processor 120)) may recognize objects contained in the image by using the cloud (e.g., server 108 in FIG. 1 (processor of the server)). For example, the electronic device (e.g., electronic device 101 in FIG. 1 (processor 120)) may send a raw image obtained using a camera (e.g., camera 180) to the cloud (e.g., server 108). For example, the electronic device (e.g., electronic device 101) may receive information about one or more objects included in the raw image based on image recognition from the cloud (e.g., server 108). For example, the electronic device (e.g., electronic device 101) may receive information about at least one object having a curved portion among the objects included in the raw image from the cloud (e.g., server 108). In one embodiment, the electronic device (e.g., electronic device 101 (processor 120), or cloud (server 108 or processor of the server)) can recognize one or more objects included in an image by using a learning model learned using artificial intelligence algorithms.

In one embodiment, the electronic device (e.g., electronic device 101 in FIG. 1 (processor 120), or server 108 (processor of the server)) may determine a curvature corresponding to at least a part of the curved portion of the recognized object. For example, the electronic device (e.g., electronic device 101 in FIG. 1) may determine curvatures corresponding to the curved portions 510 and 520. In one embodiment, the electronic device (e.g., electronic device 101 in FIG. 1) may determine virtual graphical objects 530 and 540 corresponding to the curvatures of the curved portions 510 and 520. For example, as indicated by indicia 503, the electronic device (e.g., electronic device 101 in FIG. 1) may determine a virtual graphical object 530 corresponding to the left curved portion 510 of the hair part in the image. For example, the electronic device (e.g., electronic device 101 in FIG. 1) may determine a virtual graphical object 540 corresponding to the right curved portion 520 of the hair part in the image.

In one embodiment, the electronic device (e.g., electronic device 101 in FIG. 1 (processor 120), or server 108) can detect an edge of the curved portion of the object in the image. The electronic device (e.g., electronic device 101 in FIG. 1) may determine the curvature of the detected edge.

In one embodiment, the electronic device (e.g., electronic device 101 in FIG. 1 (processor 120), or server 108) can compare the curved portion with a circle having a specific characteristic to determine the curvature. For example, the electronic device (e.g., electronic device 101 in FIG. 1) may compare the curved portion with circles having different curvatures and determine the curvature of the circle matching the curved portion as the curvature of the curved portion. In one embodiment, the electronic device (e.g., electronic device 101 in FIG. 1) may determine the circle or a part thereof matching the curved portion as a virtual graphical object.

In one embodiment, the electronic device (e.g., electronic device 101 in FIG. 1 (processor 120)) may send a raw image to the cloud (e.g., server 180), and may receive curvature information corresponding to at least a part of the curved portion of a recognized object in the raw image from the cloud (e.g., server 180). In one embodiment, the electronic device (e.g., electronic device 101 (processor 120), or cloud (server 108 or processor of the server)) can determine the curvature corresponding to at least a part of the curved portion of an object among the objects contained in an image by using a learning model learned using artificial intelligence algorithms.

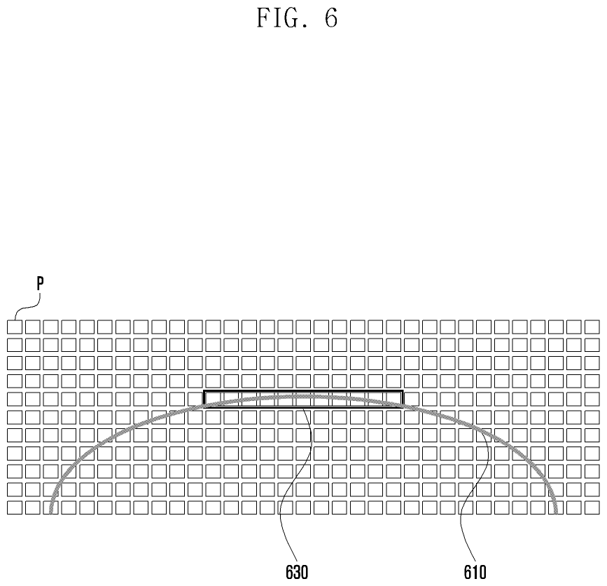

FIG. 6 illustrates operations of the electronic device according to certain embodiments of the present disclosure. Specifically, FIG. 6 illustrates operations of the electronic device to determine the filter attribute.

In one embodiment, the electronic device (e.g., electronic device 101 in FIG. 1 (processor 120), server 108 (processor of the server), or external electronic device 300 in FIG. 3 (processor 310, recognition module 331, or ISP 333)) may determine the filter attribute based on at least a part (e.g., curved portion) of the object in the image. The image may include a plurality of pixels (P). In one embodiment, the electronic device (e.g., electronic device 101 in FIG. 1 (processor 120)) may determine the filter attribute based on at least the number of pixels 630 located on the graphical object 610 of the specified curve corresponding to the curvature among the pixels representing the curved portion included in the image. For example, the attributes of a filter may include at least one of the number of filter taps, the cutoff frequency, the center frequency, the filter type, the cutoff band, the passband, or the passband gain.

For example, the electronic device (e.g., electronic device 101 in FIG. 1 (processor 120), or server 108 (processor of the server)) may determine a virtual graphical object 610 corresponding to the curved portion in the image. For example, the virtual graphical object 610 may correspond to the curvature of the curved portion of an object in the image. For example, the virtual graphical object 610 may be in the form of a circle or a part thereof having the same curvature as the curved portion. For example, the electronic device (e.g., electronic device 101 in FIG. 1) can determine the curvature by comparing the curved portion with a virtual circle having a specified characteristic. For example, the electronic device (e.g., electronic device 101 of FIG. 1) may identify the number of pixels 630 located on the virtual graphical object 610. For example, the electronic device (e.g., electronic device 101 in FIG. 1) may identify the number of pixels located on a tangent line of the virtual graphical object 610 and also located on the virtual graphical object 610. For example, in FIG. 6, the total number of pixels, in the same column, located on a tangent line of the virtual graphical object 610 is 11. In one embodiment, the electronic device (e.g., electronic device 101 in FIG. 1 (processor 120)) may determine the attributes of the filter based on at least the number of identified pixels. In certain embodiments, the electronic device (e.g., electronic device 101 in FIG. 1 (processor 120)) may determine at least one of the number of filter taps, the cutoff frequency, the center frequency, the filter type, the cutoff band, the passband, or the passband gain on the basis of at least the number of recognized or identified pixels. For example, the electronic device (e.g., electronic device 101 in FIG. 1) may determine the number of filter taps to be 11. In certain embodiments, the electronic device (e.g., electronic device 101 in FIG. 1 (processor 120)) may determine the number of recognized pixels 630 as the number of filter taps, or may determine the number of filter taps to be an appropriate value different from the number of recognized pixels 630.

In one embodiment, the electronic device (e.g., electronic device 101 in FIG. 1 (processor 120), or server 108 (processor of the server)) may determine the thickness of the graphical object 610 or the criteria for determining whether one or more pixels 630 are located on the graphical object 610 according to a user input. For example, the number of pixels 630 located on the virtual graphical object 610 may be different depending on the size and thickness of the virtual graphical object 610. For example, the electronic device may set a criterion for determining whether to recognize or count only a pixel that completely overlaps the graphical object 610 or whether to recognize or count a pixel that at least partially overlaps the graphical object 610.

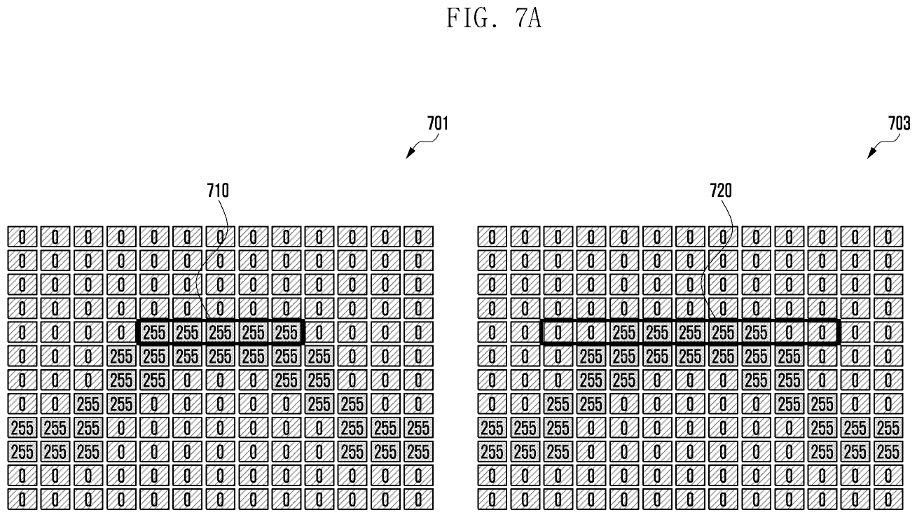

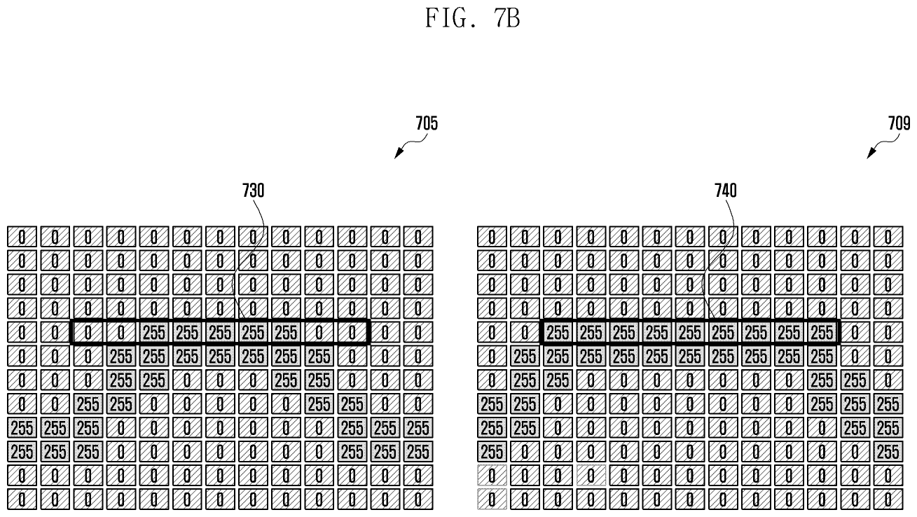

FIGS. 7A and 7B illustrate operations of the electronic device according to certain embodiments of the present disclosure.

In FIG. 7A, filters with different numbers of filter taps are applied to the same image. In one embodiment, the electronic device (e.g., electronic device 101 in FIG. 1 (processor 120), server 108 (processor of the server), or external electronic device 300 in FIG. 3 (processor 310, recognition module 331, or ISP 333)) may determine the number of filter taps based on at least the number of pixels located on the graphical object of a specified curve corresponding to the curvature among the pixels representing at least a part of the curved portion included in the image. For example, as indicated by indicia 701, the electronic device (e.g., electronic device 101 in FIG. 1) may determine the number of filter taps to be 5. For example, as indicated by indicia 703, the electronic device (e.g., electronic device 101 in FIG. 1) may determine the number of filter taps to be 9. For example, when a simulation is performed using a Kaiser window with cutoff frequencies of 0.2 pi rad/sample and 0.8 pi rad/sample for a bandpass filter, the power of the pass band can be 99 in case (701) where the number of filter taps is 5, and the power of the pass band can be 24 in case (703) where the number of filter taps is 9. That is, even if the filters having the same frequency characteristics are applied, a large difference may occur in the power of the pass band depending on the number of filter taps. For example, when image processing is performed to enhance the edge of an image (edge enhancement image processing), as the degree of enhancement is determined based on the power of the pass band, the result of image correction can vary considerably depending on the number of filter taps. In one embodiment, the electronic device (e.g., electronic device 101 in FIG. 1) may recognize at least one object having a curved portion in the image and adaptively determine the filter attribute (e.g., number of filter taps) according to the curvature of the curved portion. If there is an object having a curved portion in the image, the electronic device may readily apply the same number of filter taps based on the set reference curvature. Hence, image processing can be performed more effectively, and a high-quality image can be provided.

In FIG. 7B, the filter with the same number of filter taps (9 filter taps) is applied to different images. For example, when a simulation is performed using a Kaiser window with cutoff frequencies of 0.2 pi rad/sample and 0.8 pi rad/sample for a bandpass filter, the power of the pass band can be 24 in case (705), and the power of the pass band can be 3 in case (709). That is, when a filter having the same number of filters is applied to different images, the power of the pass band may be different. In one embodiment, the electronic device (e.g., electronic device 101 in FIG. 1) may recognize at least one object having a curved portion in the image, and determine the filter attribute (e.g., number of filter taps) adaptively according to the curvature of the curved portion, and thus may apply a filter with a number of filter taps optimized along the edge boundaries of the different images. Hence, the electronic device (e.g., electronic device 101 in FIG. 1) can enhance the quality of the image by applying an optimized filter according to the characteristics of the object included in the image. For example, the electronic device (e.g., electronic device 101 in FIG. 1) can improve the image processing efficiency by correcting an object having the same curvature using a filter with the same number of filter taps.

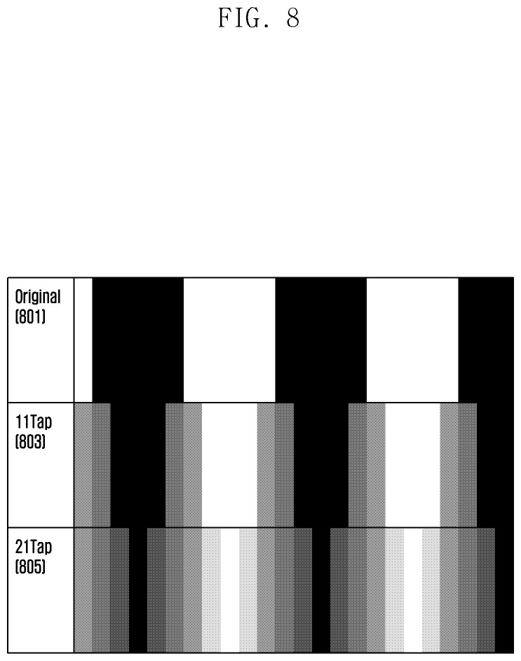

FIG. 8 illustrates operations of the electronic device according to certain embodiments of the present disclosure.

FIG. 8 shows the result of applying filters having the same frequency characteristics but having different numbers of filter taps to the same original image 801. For example, in FIG. 8, Gaussian filters having 11 filter taps and 21 filter taps with the same cutoff frequency are applied to the same original image 801. Here, image 803 is a result of applying a filter with 11 filter taps, and image 805 is a result of applying a filter with 21 filter taps. Different images may be output if the number of filter taps is different even though filters with the same frequency characteristics are used. In one embodiment, the electronic device (e.g., electronic device 101 in FIG. 1 (camera 180)) may recognize at least one object having a curved portion in the image, determine the filter attribute (e.g., number of filter taps) adaptively according to the curvature of the curved portion, and correct at least a part of the curved portion by using a filter with the determined attribute. Hence, it is possible to provide a higher quality image by applying an appropriate filter according to the characteristics of an object in the image.

For example, the original image 801 has very sharp edges. Image 803 with an 11 tap filter has somewhat smoother edges, while image 805 has the smoothest edges.

According to certain embodiments of the present disclosure, the electronic device may include a memory and a processor. The processor may be configured to: recognize at least one object having a curved portion among one or more objects included in an image through image recognition; determine the curvature corresponding to at least a part of the curved portion of the at least one object; determine a filter attribute based on at least the number of pixels located on the graphical object of a specified curve corresponding to the curvature among one or more pixels representing the at least a part of the curved portion in the image; and correct at least a part of the curved portion using a filter set based on at least the filter attribute.

In one embodiment, the processor may be configured to determine the curvature by comparing the curved portion with a curve having a specified characteristic (e.g., circle, ellipse, or arc).

In one embodiment, the processor may be configured to perform an edge enhancement operation on the curved portion as part of image correction.

In one embodiment, the filter attribute may include at least one of the number of filter taps, the cutoff frequency, the center frequency, the filter type, the cutoff band, the passband, or the passband gain.

In one embodiment, the processor may be configured to determine the direction to apply the filter according to the characteristics of at least a part of the curved portion.

In one embodiment, the processor may be configured to determine the thickness of the graphical object or a criterion for determining whether one or more pixels are located on the graphical object according to a user input.

In one embodiment, the processor may be configured to detect an edge of the curved portion and determine the curvature of the detected edge.

In one embodiment, the electronic device may further include a camera and a communication circuit. The processor may be configured to: transmit a raw image obtained using the camera to a cloud outside the electronic device via the communication circuit; and receive, from the cloud, information about one or more objects included in the raw image generated through image recognition.

In one embodiment, the processor may be configured to use a learning model learned through artificial intelligence algorithms so as to recognize one or more objects included in the image or to determine the curvature corresponding to at least a part of the curved portion in at least one object.

In one embodiment, the processor may be configured to: process a portion of the raw image via an image signal processor (ISP); receive the result of processing another portion of the raw image through an ISP from the cloud; and generate the final result based on the result of ISP processing of the portion and the received result of ISP processing of the another portion.

In one embodiment, the electronic device can use the cloud system to back up, edit or create images or videos. For example, the electronic devices can provide a variety of user experience by using the cloud system to apply various computer vision techniques to images or videos. In one embodiment, the cloud system can support learning functions. For example, the cloud system may include a very large database and a machine learning engine.

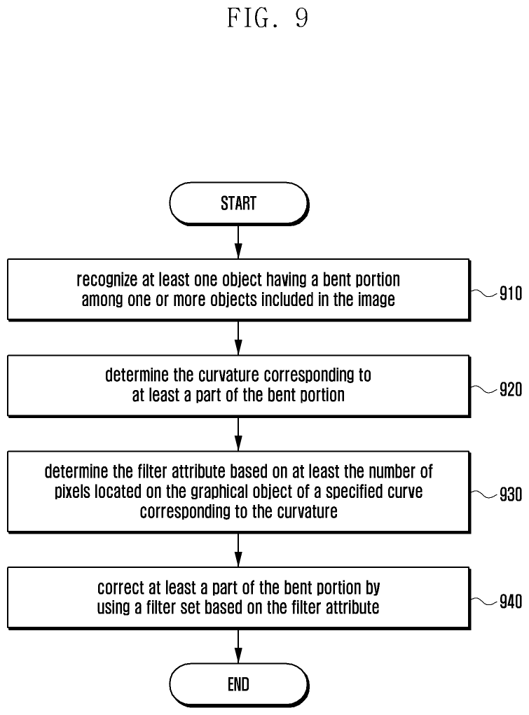

FIG. 9 is a flowchart of an image processing method of the electronic device according to certain embodiments of the present disclosure.

In one embodiment, at operation 910, the electronic device (e.g., electronic device 101 in FIG. 1 (processor 120), server 108 (processor of the server), or external electronic device 300 in FIG. 3 (processor 310, recognition module 331, or ISP 333)) may recognize at least one object having a curved portion among the objects included in the image. For example, the electronic device (e.g., electronic device 101 in FIG. 1 (processor 120), or server 108 (processor of the server)) may recognize a human hair part having a curved portion among the objects in the image (e.g., hairs, clothes, human body, or background). In certain embodiments, the electronic device (e.g., electronic device 101 in FIG. 1 (processor 120), or server 108 (processor of the server)) may recognize various types of objects having a curved portion in the image other than human hairs.

In one embodiment, the electronic device (e.g., electronic device 101 in FIG. 1 (processor 120)) may recognize objects contained in the image by using the cloud (e.g., server 108 in FIG. 1). For example, the electronic device (e.g., electronic device 101 in FIG. 1 (processor 120)) may send a raw image obtained using a camera (e.g., camera 180) to the cloud (e.g., server 108 (processor of the server)). For example, the electronic device (e.g., electronic device 101 in FIG. 1 (processor 120)) may receive information about one or more objects included in the raw image obtained based on image recognition from the cloud (e.g., server 108 (processor of the server)). For example, the electronic device (e.g., electronic device 101 in FIG. 1 (processor 120)) may receive information about at least one object having a curved portion among the objects included in the raw image from the cloud (e.g., server 108 (processor of the server)). In one embodiment, the electronic device (e.g., electronic device 101 in FIG. 1 (processor 120), or cloud (server 108 or processor of the server)) can recognize one or more objects included in an image by using a learning model learned using artificial intelligence algorithms.

In one embodiment, at operation 920, the electronic device (e.g., electronic device 101 in FIG. 1 (processor 120), or server 108 (processor of the server)) may determine the curvature corresponding to at least a part of the curved portion of the recognized object.

In one embodiment, the electronic device (e.g., electronic device 101 in FIG. 1 (processor 120), or server 108 (processor of the server)) can compare the curved portion with a circle having a specific characteristic to determine the curvature. For example, the electronic device (e.g., electronic device 101 in FIG. 1 (processor 120), or server 108 (processor of the server)) may compare the curved portion with circles having different curvatures and determine the curvature of the circle matching the curved portion as the curvature of the curved portion. In one embodiment, the electronic device (e.g., electronic device 101 in FIG. 1 (processor 120), or server 108 (processor of the server)) may determine the circle or a part thereof matching the curved portion as a virtual graphical object.

In one embodiment, the electronic device (e.g., electronic device 101 in FIG. 1 (processor 120), or server 108 (processor of the server)) can detect an edge of the curved portion of the object in the image. The electronic device (e.g., electronic device 101 in FIG. 1 (processor 120), or server 108 (processor of the server)) may determine the curvature of the detected edge.

In one embodiment, the electronic device (e.g., electronic device 101 in FIG. 1 (processor 120)) may send a raw image to the cloud (e.g., server 180 (processor of the server)), and may receive curvature information corresponding to at least a part of the curved portion of a recognized object in the raw image from the cloud. In one embodiment, the electronic device (e.g., electronic device 101 in FIG. 1 (processor 120), or cloud (server 108 or processor of the server)) can determine the curvature corresponding to at least a part of the curved portion of an object among the objects contained in the image by using a learning model learned using artificial intelligence algorithms.

In one embodiment, at operation 930, the electronic device (e.g., electronic device 101 in FIG. 1 (processor 120), or server 108 (processor of the server)) may determine the filter attribute based on at least the number of pixels located on the graphical object of a specified curve corresponding to the curvature.

In one embodiment, the electronic device (e.g., electronic device 101 in FIG. 1 (processor 120), or server 108 (processor of the server)) may determine the filter attribute based on at least a part (e.g., curved portion) of the object in the image. The image may include a plurality of pixels (P). In one embodiment, the electronic device (e.g., electronic device 101 in FIG. 1 (processor 120), or server 108 (processor of the server)) may determine the filter attribute based on at least the number of pixels located on the graphical object of the specified curve corresponding to the curvature among the pixels representing the curved portion included in the image. For example, the attributes of a filter may include at least one of the number of filter taps, the cutoff frequency, the center frequency, the filter type, the cutoff band, the passband, or the passband gain.

In one embodiment, the electronic device (e.g., electronic device 101 in FIG. 1 (processor 120), or server 108 (processor of the server)) may determine a virtual graphical object corresponding to the curved portion in the image. For example, the virtual graphical object may correspond to the curvature of the curved portion of an object in the image. For example, the electronic device (e.g., electronic device 101 in FIG. 1 (processor 120), or server 108 (processor of the server)) can determine the curvature by comparing the curved portion with a virtual circle having a specified characteristic. For example, the electronic device (e.g., electronic device 101 in FIG. 1 (processor 120), or server 108 (processor of the server)) may identify the number of pixels located on the virtual graphical object. For example, the electronic device (e.g., electronic device 101 in FIG. 1 (processor 120), or server 108 (processor of the server)) may identify the number of pixels that are located on a tangent line of the virtual graphical object and overlap the virtual graphical object.

In one embodiment, the electronic device (e.g., electronic device 101 in FIG. 1 (processor 120), or server 108 (processor of the server)) may determine at least one of the number of filter taps, the cutoff frequency, the center frequency, the filter type, the cutoff band, the passband, or the passband gain on the basis of at least the number of recognized or identified pixels. In certain embodiments, the electronic device (e.g., electronic device 101 in FIG. 1 (processor 120), or server 108 (processor of the server)) may determine the number of recognized pixels as the number of filter taps, or may determine the number of filter taps to be an appropriate value different from the number of recognized pixels. In one embodiment, the electronic device (e.g., electronic device 101 in FIG. 1 (processor 120), or server 108 (processor of the server)) may determine the thickness of a virtual graphical object or a criteria for determining whether one or more pixels are located on the graphical object, according to a user input. For example, the electronic device (e.g., electronic device 101 in FIG. 1 (processor 120), or server 108 (processor of the server)) may set a criterion for determining whether to recognize or count only a pixel that completely overlaps the graphical object or whether to recognize or count a pixel that at least partially overlaps the graphical object.

In one embodiment, at operation 940, the electronic device (e.g., electronic device 101 in FIG. 1 (processor 120), or server 108 (processor of the server)) can correct at least a part of the curved portion by using a filter set based on the determined filter attribute. In one embodiment, the electronic device (e.g., electronic device 101 in FIG. 1 (processor 120), or server 108 (processor of the server)) can correct at least a part of the curved portion in the image by applying the filter. For example, the electronic device (e.g., electronic device 101 in FIG. 1 (processor 120), or server 108 (processor of the server)) may perform edge enhancement on the curved portion. For example, through image correction, the electronic device (e.g., electronic device 101 in FIG. 1 (processor 120), or server 108 (processor of the server)) can enhance the resolution of the image (object), make the curved portion more neat or smooth, or more sharply correct the color, brightness, or saturation of the image (object).

According to certain embodiments of the present disclosure, the image processing method for the electronic device may include: recognizing at least one object having a curved portion among one or more objects included in an image through image recognition; determining the curvature corresponding to at least a part of the curved portion of the at least one object; determining a filter attribute based on at least the number of pixels located on the graphical object of a specified curve corresponding to the curvature among one or more pixels representing the at least a part of the curved portion in the image; and correcting at least a part of the curved portion using a filter set based on at least the filter attribute.

In one embodiment, determining the curvature may include determining the curvature by comparing the curved portion with a curve having a specified characteristic (e.g., circle, ellipse, or arc).

In one embodiment, correcting at least a part of the curved portion may include performing an edge enhancement operation on the curved portion.

In one embodiment, the filter attribute may include at least one of the number of filter taps, the cutoff frequency, the center frequency, the filter type, the cutoff band, the passband, or the passband gain.

In one embodiment, the image processing method may further include determining the direction to apply the filter according to the characteristics of at least a part of the curved portion.

In one embodiment, the image processing method may further include determining the thickness of the graphical object or a criterion for determining whether one or more pixels are located on the graphical object according to a user input.

In one embodiment, determining the curvature may include detecting an edge of the curved portion and determining the curvature of the detected edge.

In one embodiment, the image processing method may further include: transmitting a raw image obtained using a camera to a cloud outside the electronic device via a communication circuit; and receiving, from the cloud, information about one or more objects included in the raw image generated through image recognition.

In one embodiment, recognizing at least one object or determining the curvature may be performed by using a learning model learned through artificial intelligence algorithms.

In one embodiment, the image processing method may further include: processing a portion of the raw image via an image signal processor (ISP); receiving the result of processing another portion of the raw image through an ISP from the cloud; and generating the final result based on the result of ISP processing of the raw image portion and the received result of ISP processing of the another raw image portion.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program #40) including one or more instructions that are stored in a storage medium (e.g., internal memory #36 or external memory #38) that is readable by a machine (e.g., the electronic device #01). For example, a processor (e.g., the processor #20) of the machine (e.g., the electronic device #01) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a memory; and
at least one processor,
wherein the at least one processor is configured to:
recognize at least one object having a curved portion in an image;
determine a curvature corresponding to at least a part of the curved portion of the at least one object;
determine a filter attribute based on at least a number of pixels located on a pre-existing graphical object of a specified curve corresponding to the curvature among one or more pixels representing the at least a part of the curved portion in the image; and
correct the at least the part of the curved portion using a filter set based on at least the filter attribute.

2. The electronic device of claim 1, wherein the at least one processor is configured to determine the curvature by comparing the curved portion with a curve having a specified property in the pre-existing graphical object.

3. The electronic device of claim 1, wherein correct the at least the part of the curved portion comprises performing an edge enhancement operation on the curved portion.

4. The electronic device of claim 1, wherein the filter attribute includes at least one of a number of filter taps, a cutoff frequency, a center frequency, a filter type, a cutoff band, a passband, or a passband gain.

5. The electronic device of claim 1, wherein the at least one processor is configured to determine a direction to apply the filter according to characteristics of the at least the part of the curved portion.

6. The electronic device of claim 1, wherein the at least one processor is to configured to determine a thickness of the pre-existing graphical object or a criterion for determining whether one or more pixels are located on the graphical object according to a user input.

7. The electronic device of claim 1, wherein the at least one processor is configured to detect an edge of the curved portion and determine the curvature of the detected edge.

8. The electronic device of claim 1, further comprising:
a camera; and
a communication circuit,
wherein the at least one processor is configured to:
transmit a raw image obtained using the camera to a cloud outside the electronic device via the communication circuit; and
receive, from the cloud, information about one or more objects included in the raw image, wherein the one or more objects includes the at least one object.

9. The electronic device of claim 1, wherein the one or more processor is configured to use a learning model learned through artificial intelligence algorithms so as to recognize one or more objects included in the image or to determine the curvature corresponding to the at least the part of the curved portion in the at least one object.

10. The electronic device of claim 8, wherein the at least one processor is configured to:
process a portion of the raw image via an image signal processor (ISP);
receive the result of processing another portion of the raw image through an ISP from the cloud; and
generate a final result based on a result of ISP processing of the portion of the raw image and the received result of ISP processing of the portion of the another raw image.

11. A method of image processing for an electronic device, the method comprising:
recognizing at least one object having a curved portion in an image;
determining a curvature corresponding to at least a part of the curved portion of the at least one object;
determining a filter attribute based on at least a number of pixels located on a pre-existing graphical object of a specified curve corresponding to the curvature among one or more pixels representing the at least the part of the curved portion in the image; and
correcting the at least the part of the curved portion by using a filter set based on at least the filter attribute.

12. The method of claim 11, wherein determining a curvature comprises determining the curvature by comparing the curved portion with a curve having a specified property in the pre-existing graphical object.

13. The method of claim 11, wherein correcting the at least the part of the curved portion comprises performing an edge enhancement operation on the curved portion.

14. The method of claim 11, wherein the filter attribute includes at least one of a number of filter taps, a cutoff frequency, a center frequency, a filter type, a cutoff band, a passband, or a passband gain.

15. The method of claim 11, further comprising determining a direction to apply the filter according to characteristics of the at least the part of the curved portion.

16. The method of claim 11, further comprising determining a thickness of the pre-existing graphical object or determining whether one or more pixels are located on the graphical object according to a user input.

17. The method of claim 11, wherein determining a curvature comprises detecting an edge of the curved portion and determining the curvature of the detected edge.

18. The method of claim 11, further comprising:
transmitting a raw image obtained using a camera to a cloud outside the electronic device via a communication circuit; and
receiving, from the cloud, information about one or more objects included in the raw image, wherein the one or more objects includes the at least one object.

19. The method of claim 18, wherein recognizing at least one object or determining a curvature is carried out by using a learning model learned through artificial intelligence algorithms.

20. The method of claim 18, further comprising:
processing a portion of the raw image via an image signal processor (ISP);
receiving a result of processing another portion of the raw image through an ISP from the cloud; and
generating a final result based on a result of ISP processing of the portion of the raw image and the received result of ISP processing of the portion of the another raw image.
